(19) United States
(12) Patent Application Publication
(10) Pub. No.: US 2021/0240021 A1
(43) Pub. Date: Aug. 5, 2021

(54) PRIVACY DISPLAYS OPERATING IN TWO LUMINOSITY MODES

(71) Applicant: Hewlett-Packard Development Company, L.P., Spring, TX (US)

(72) Inventors: Hsing-Hung Hsieh, Taipei City (TW); Wan Ching Lee, Taipei City (TW); Ann Alejandro Villegas, Spring, TX (US)

(73) Assignee: Hewlett-Packard Development Company, L.P., Spring, TX (US)

(21) Appl. No.: 17/048,728

(22) PCT Filed: Oct. 2, 2018
(86) PCT No.: PCT/US2018/053851

§ 371 Date: Oct. 19, 2020

(51) Int. Cl. G02F 1/13; G02F 1/1334; G02F 1/1335

(52) U.S. Cl. CPC G02F 1/1323; G06F 21/84; G02F 1/133607; G02F 1/1334

(57) ABSTRACT

A privacy display may include a collimated backlight (CBL) layer; a polymer-dispersed liquid crystal (PDLC) layer; and a liquid crystal display (LCD) layer; wherein the PDLC layer is, upon selective application of a voltage, operates in a sharing mode and a privacy mode, the sharing mode being made to operate at a first luminance mode and a second luminance mode; wherein, at the second luminance mode, the voltage is not applied to the PDLC layer and, at the first luminance mode, the voltage is applied to the PDLC; and wherein a minimal luminance of the second luminance mode is 1.5 times or greater than a maximum luminance of the first luminance mode.

### BACKGROUND

Display devices such as televisions and computer screens allow a user to view images and/or data presented thereon. In some examples, the images and/or data presented therein may be viewed by any number of users. However, some of the images and/or data presented on the display devices may be personal or sensitive data that should not be viewed by others.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a privacy display according to an example of the principles described herein.

FIG. 2 shows a light distribution graph depicting the first luminance mode and second luminance mode of FIG. 1 according to an example of the principles described herein.

FIG. 3 is a flowchart showing a method of operating a display device according to an example of the principles described herein.

FIG. 4 is a block diagram of the privacy display of FIG. 1 showing the privacy display in a privacy mode according to an example of the principles described herein.

FIG. 5 shows a block diagram depicting a privacy display operating in a first luminance mode during a sharing mode according to an example of the principles described herein.

FIG. 6 is a block diagram of the privacy display operating in a second luminance mode during a sharing mode according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Display devices may comprise a number of layers that help to present an image to the user. In some examples a display device may include a backlight source that lights, for example, a liquid crystal display (LCD). The LCD may, in an example, use light-modulating properties of liquid crystals that do not emit light directly, but instead uses the backlight source and/or reflectors to produce images on the display device.

In some examples, an additional layer may be sandwiched between the backlight source and the LCD. This additional layer may turn the display device into a privacy display. The additional layer may, in an example, include a polymer-dispersed liquid crystal (PDLC) layer. Upon application of a voltage to the PDLC layer, the layer may be selectively rendered translucent, semitransparent, opaque, and/or clear depending on the amount of liquid crystals dissolved or dispersed into or throughout the liquid polymer of the PDLC layer. In these examples, the application of the voltage to the PDLC layer places the display device in a privacy mode because the liquid crystals placed within the liquid polymer are aligned allowing light to pass through to the user and not scattered. When the voltage is not applied to the PDLC layer, the liquid crystals in the PDLC layer are not aligned thereby scattering the light and allowing the image displayed on the display device to be viewed at multiple angles.

However, with this type of selective privacy mode, a brightness of the display at the center of the display may be limited. This brightness limitation may be a result of the brightness being lowered so that other persons are not able to view the images on the display. As the brightness of the image presented in the privacy mode increases, the brightness at angles off of center starts to increase. Additionally, in sharing mode of this display device, the center brightness of the display device may also be limited. This may be a result of the scattering of the light by the liquid crystals in the PDLC layer. As a result, while in sharing mode, the display device may be incapable of reaching certain brightness levels.

The present specification describes a privacy display, that includes a collimated backlight (CBL) layer; a polymer-dispersed liquid crystal (PDLC) layer; and a liquid crystal display (LCD) layer; wherein the PDLC layer is, upon selective application of a voltage, operates in a sharing mode and a privacy mode, the sharing mode being made to operate at a first luminance mode and a second luminance mode; wherein, at the first luminance mode, the voltage is not applied to the PDLC layer and, at the second luminance mode, the voltage is applied to the PDLC; and wherein a minimal luminance of the second luminance mode is 1.5 times or greater than a maximum luminance of the first luminance mode.

The present specification also describes a method of operating a display device, that includes receiving input to selectively switch between a privacy mode and a sharing mode with a polymer-dispersed liquid crystal (PDLC) layer; and when in a sharing mode and based on a threshold luminance level, selectively switching between a first luminance mode and a second luminance mode; wherein a minimal luminance of the second luminance mode is 1.5 times or greater than a maximum luminance of the first luminance mode.

The present specification further describes a computer program product for operating a display device, the computer program product that includes a computer readable storage medium comprising computer usable program code embodied therewith, the computer usable program code to, when executed by a processor: receiving input to selectively switch between a privacy mode and a sharing mode with a polymer-dispersed liquid crystal (PDLC) layer; when in a sharing mode and based on a threshold luminance level, selectively switching between a first luminance mode and a second luminance mode; and set a minimal luminance of the second luminance mode at 1.5 times or greater than a maximum luminance of the first luminance mode.

As used in the present specification and in the appended claims, the term “translucent” is meant to be understood as semitransparent allowing some of a total amount of light to pass to a user. The present specification may describe a layer that is translucent. In this example, the layer may, therefore, allow a portion of a total amount of light to pass through the layer.

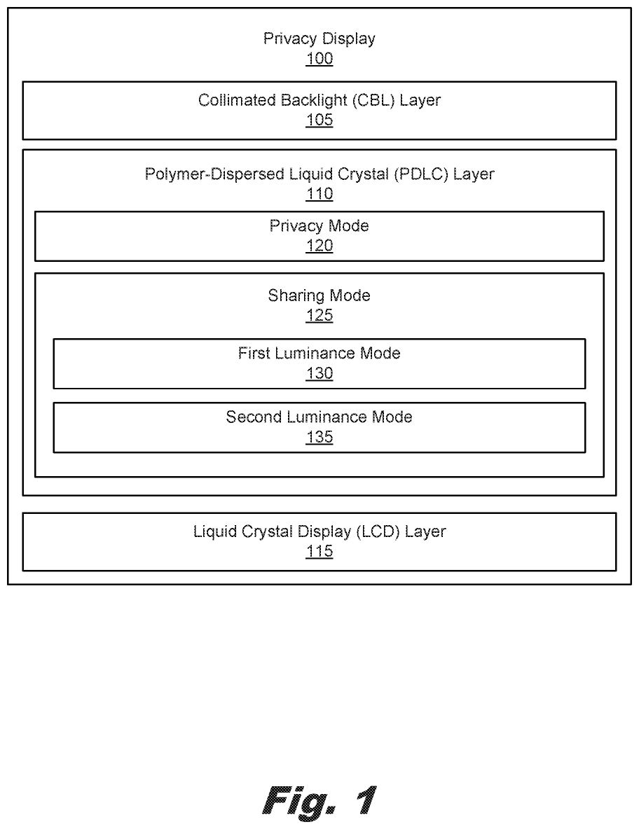

Turning now to the figures, FIG. 1 is a block diagram of a privacy display (100) according to an example of the principles described herein. In an example, the privacy display (100) may include a collimated backlight (CBL) layer (105), a polymer-dispersed liquid crystal (PDLC) layer (110), and a liquid crystal display (LCD) layer (115). The privacy display (100) may be arranged with the PDLC layer (110) being sandwiched between the CBL layer (105) and the LCD layer (115). However, a number of other arrangements may be used and the present specification contemplates these other arrangements of layers.

The CBL layer (105) may be any type of backlight source that produces a collimated light source. Because the rays of the collimated light produced by the CBL layer (105) are generally parallel, the spread of light produced by the CBL layer (105) is directed generally perpendicularly out of the CBL layer (105) and to the PDLC layer (110).

The PDLC layer (110) may include any amount of liquid crystals that are dissolved or dispersed into a liquid polymer. The formation process of the PDLC layer (110) may also include a solidification or curing of the polymer. During the solidification process, the change of the polymer from a liquid to a solid may cause the liquid crystals therein to become incompatible with the, now, solid polymer and form droplets throughout the solid polymer. The curing time and amount of liquid crystals within the liquid polymer prior to curing among other factors may determine the translucency of the PDLC layer (110) when a voltage is applied to this layer (110) resulting in a privacy mode of the privacy display (100). Indeed, in an example, the curing time and amount of liquid crystals within the liquid polymer prior to curing among other factors may determine the amount of light scattered when a voltage is not applied to the layer resulting in a sharing mode of the privacy display (100).

The LCD layer (115) may be any type of liquid crystal display layer that implements liquid crystals to, with the collimated backlight from the CBL layer (105), direct light to a user's eyes. The LCD layer (115) itself may include a number of layers itself including, in some examples, a number of polarizing filter layers, a number of glass layers, and a layer of liquid crystal. Additional types and numbers of layers may be present in the LCD layer (115) and the present specification contemplates the use of these additional and distinct layers.

In an example, the PDLC layer (110) may, upon selective application of a voltage thereto, operate in a sharing mode (125) and a privacy mode (120). In this example, the PDLC layer (110) operates in a privacy mode when the voltage is applied to the PDLC layer (110) thereby aligning the liquid crystal disposed within the PDLC layer (110). In this configuration, the PDLC layer (110) allows the collimated light from the CBL layer (105) to shine directly into the LCD layer (115). Additionally, the PDLC layer (110) operates in the sharing mode when the voltage is not applied to the PDLC layer (110) thereby misaligning the liquid crystals within the PDLC layer (110). In this configuration, the collimated light from the CBL layer (105) is scattered by the misaligned liquid crystals causing the light passing through the PDLC layer (110) to be scattered and also causing the scattered light to pass into the LCD layer (115) which scatters the light.

In addition to the privacy display (100) being capable of operating in a privacy mode and a sharing mode, the privacy display (100) may operate in a sharing mode (125) at a first luminance mode (130) and a second luminance mode (135). As described herein, the first luminance mode (130) and second luminance mode (135) may provide for a privacy display (100) that maintains a viewing angle off of center regardless of the luminosity change to the privacy display (100). In examples presented herein, a threshold luminosity of the privacy display (100) triggers a change in the PDLC layer (110) from transparent to translucent or from translucent to transparent depending on the decrease or increase, respectively, of the luminosity of the privacy display (100).

In an example and while the privacy display (100) is operating in a sharing mode (125), the privacy display (100) may set the PDLC layer (110) to transparent when the luminosity setting on the privacy display (100) is above a certain threshold. In an example, this threshold may be 400 nits. Similarly, in this example, when the privacy display (100) is operating in a sharing mode (125), the privacy display (100) may set the PDLC layer (110) to translucent when the luminosity setting on the privacy display (100) is below the threshold. Following this example, the PDLC layer (110) is set to translucent when the luminosity is below 400 nits.

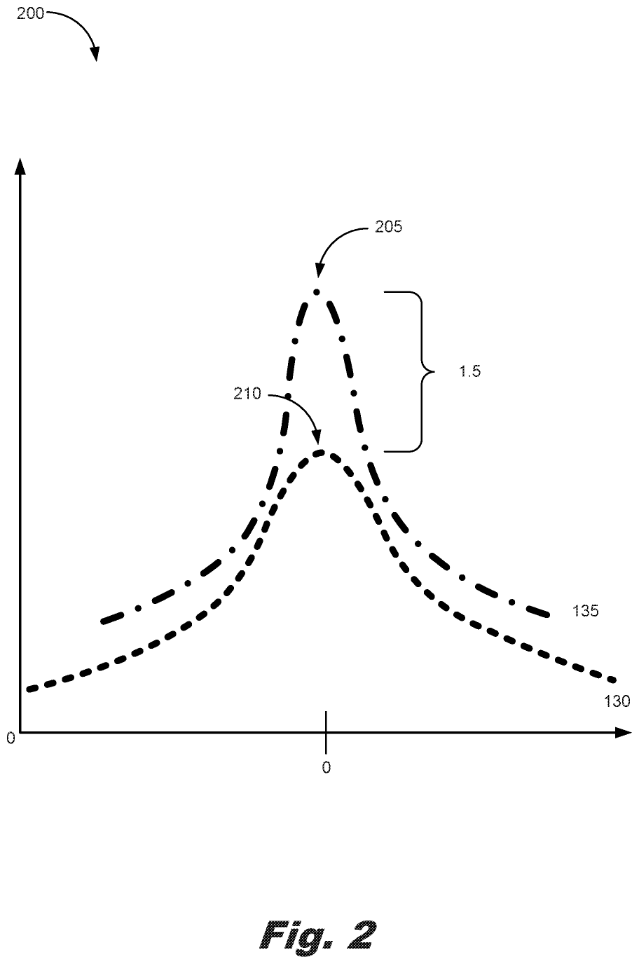

In any example presented herein, a minimal luminance of the second luminance mode (135) is 1.5 times or greater than a maximum luminance of the first luminance mode (130). FIG. 2 shows a light distribution graph (200) depicting the first luminance mode (130) and second luminance mode (135) of FIG. 1 according to an example of the principles described herein. In this light distribution graph (200), the x-axis is the viewing angle of a viewer relative to the privacy display (100) with the center of the privacy display (100) indicated with a “0.” The y-axis of the light distribution graph (200) shows the luminosity of the privacy display (100) with the vertex being 0 luminosity. The first luminance mode (130) and second luminance mode (135) are indicated using two different line styles. A minimal luminance (205) of the second luminance mode (135) is depicted as being, at least, 1.5 times than a maximum luminance (210) of the first luminance mode (130). Because the minimal luminance (205) of the second luminance mode (135) is set to 1.5 times that of a maximum luminance (210) of the first luminance mode (130), a user viewing at any angle on the privacy display (100) will not see a reduction in luminance when the privacy display (100) switches from the first luminance mode (130) to the second luminance mode (135). Indeed, if the difference between the minimal luminance (205) of the second luminance mode (135) and the maximum luminance (210) of the first luminance mode (130) did not include this level of differentiation, a viewer of the privacy display (100) at certain angles may detect when the luminosity of the privacy display (100) switches between the first luminance mode (130) and the second luminance mode (135).

During operation, the privacy display (100) may also initiate a color calibration process in order to maintain the color scheme presented to the user. In an example, the color calibration may begin with detecting the color gamut presented in the first luminance mode (130). Having detected the color gamut of the first luminance mode (130), the color calibration may adjust the color gamut presented to the user while in the second luminance mode (135). Alternatively, the color calibration may begin with detecting the color gamut presented in the second luminance mode (135). Having detected the color gamut of the second luminance mode (135), the color calibration may adjust the color gamut presented to the user while in the first luminance mode (130). In either example, the color gamut presented to the user while in any of the first luminance mode (130) or second luminance mode (135) may be maintained regardless of the level of luminosity of privacy display (100) presented to the user. The present specification contemplates that any types of color calibration process may be used to maintain the color gamut between the first luminance mode (130) and second luminance mode (135).

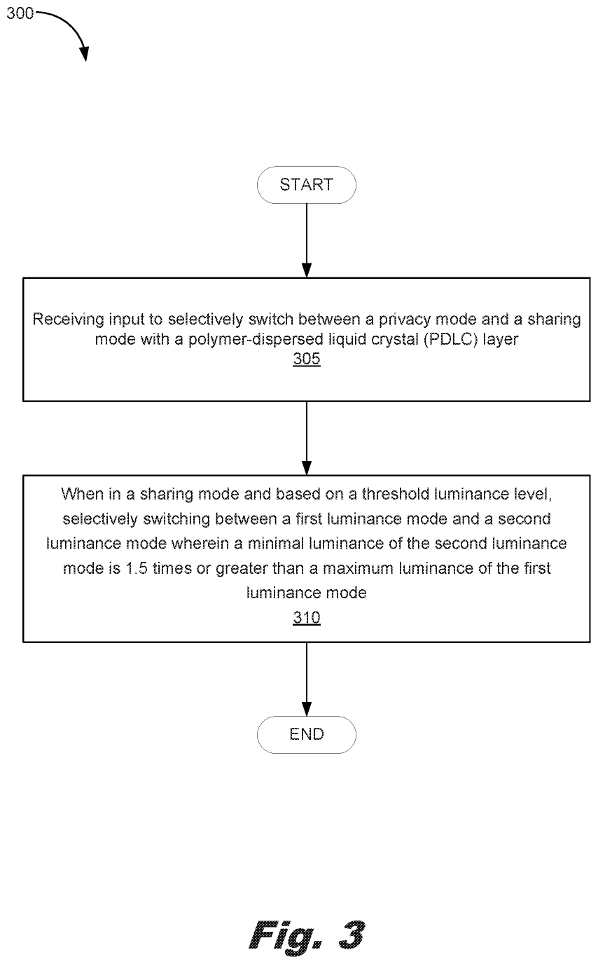

FIG. 3 is a flowchart showing a method (300) of operating a display device according to an example of the principles described herein. In this example, the display device may be the privacy display (100) as depicted and described in connection with FIG. 1. The method (300) may begin with receiving (305) input to selectively switch between a privacy mode (120) and a sharing mode (125) with a polymer-dispersed liquid crystal (PDLC) layer (110). As described, the PDLC layer (110) may be rendered either transparent or translucent based on a voltage being applied to the liquid crystals distributed within the PDLC layer (110). During a privacy mode (120), the PDLC layer (110) is rendered transparent through application of a voltage. Conversely, during the sharing mode (125), the PDLC layer (110) is rendered translucent through non-application of a voltage to the PDLC layer (110).

The method (300) may continue with, when in a sharing mode (125) and based on a threshold luminance level, selectively switching (310) between a first luminance mode (130) and a second luminance mode (135). As described herein, a minimal luminance of the second luminance mode (135) is 1.5 times or greater than a maximum luminance of the first luminance mode (130).

By implementing the method (300) described herein, a user may be able to both operate the privacy display (100) in a privacy mode (120) and a sharing mode (125). While sharing in the sharing mode (125), however, any viewer at any angle relative to the surface of the privacy display (100) may see the images being presented without noticing a reduction in luminosity when the privacy display (100) switches from the first luminance mode (130) to the second luminance mode (135). This is because the minimal luminance of the second luminance mode (135) is 1.5 times or greater than a maximum luminance of the first luminance mode (130).

In an example, the method (300) may further include initiating a color calibration process. As described herein, the color calibration may prevent a user from seeing a detectable color change when the privacy display (100), while in the sharing mode (125), switches from the first luminance mode (130) to the second luminance mode (135) or visa versa. In any example presented herein, the calibration of the color gamut presented may be based on the color gamut profiles presented in either one of the first luminance mode (130) or second luminance mode (135).

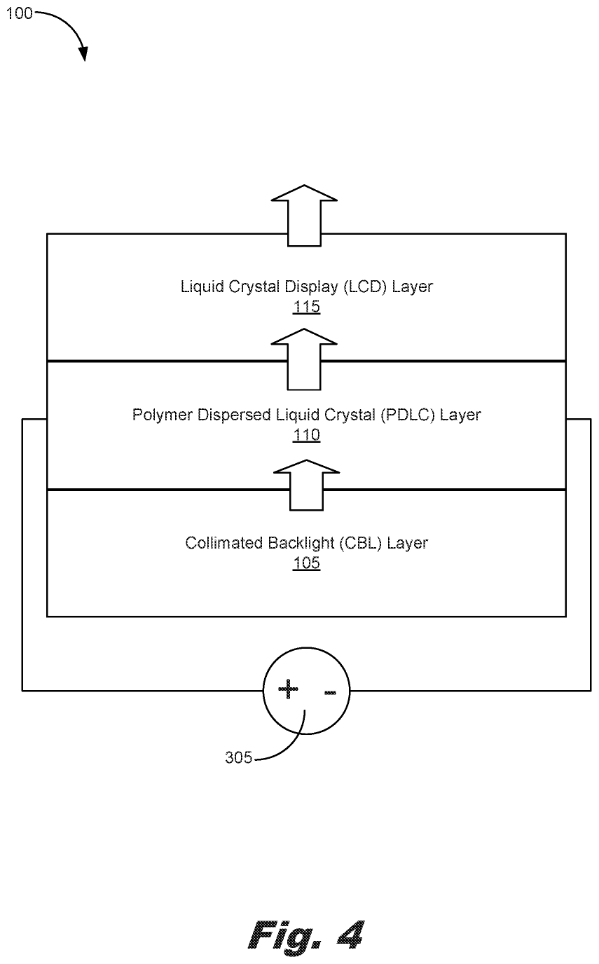

FIG. 4 is a block diagram of the privacy display (100) of FIG. 1 showing the privacy display (100) in a privacy mode (120) according to an example of the principles described herein. FIG. 4 also shows the path of light originating from the CBL layer (105), passing though the PDLC layer (110), and into the LCD layer (115) in order to present the image to the user.

The privacy display (100), and in particular, the PDLC layer (110), may be electrically coupled to a voltage source (305). The voltage source (305) may selectively provide a voltage to the PDLC layer (110) in order to render it translucent or transparent depending on whether the privacy display (100) is to be operated in a privacy mode (120), a sharing mode (125), or one of the first luminance mode (130) or second luminance mode (135).

When operated in the privacy mode (120), as depicted in FIG. 4, the CBL layer (105) provides collimated light to the PDLC layer (110). Because a voltage is applied to the PDLC layer (110) by the voltage source (305), the PDLC layer (110) is rendered transparent allowing the collimated light to pass therethrough. The collimated light then reaches the LCD layer (115) which, via the liquid crystals present in that LCD layer (115), presents the image to the user viewing the privacy display (100). Where the voltage source (305) does not apply a voltage to the PDLC layer (110), the light is scattered by the PDLC layer (110) before reaching the LCD layer (115) thereby providing to a user a sharing mode (125) of the privacy display (100).

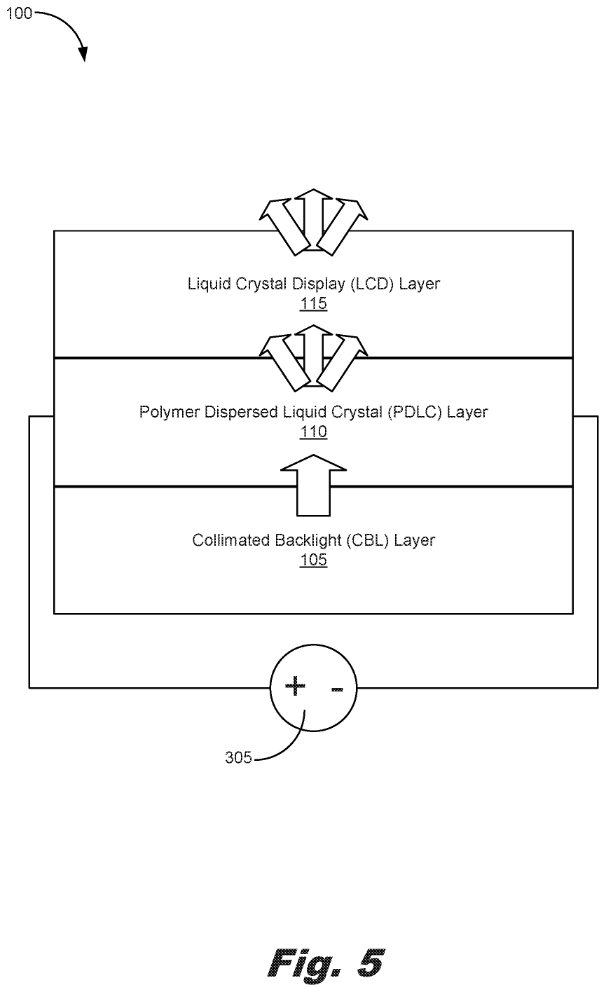

FIG. 5, however, shows the privacy display (100) operating in a first luminance mode (130) during a sharing mode (125) according to an example of the principles described herein. As described herein, the privacy display (100) may operate in the sharing mode (125) at a first luminance mode (130). At this first luminance mode (130), for example 400 nits, no voltage is applied to the PDLC layer (110) resulting in the collimated light being scattered at the PDLC layer (110) as described herein.

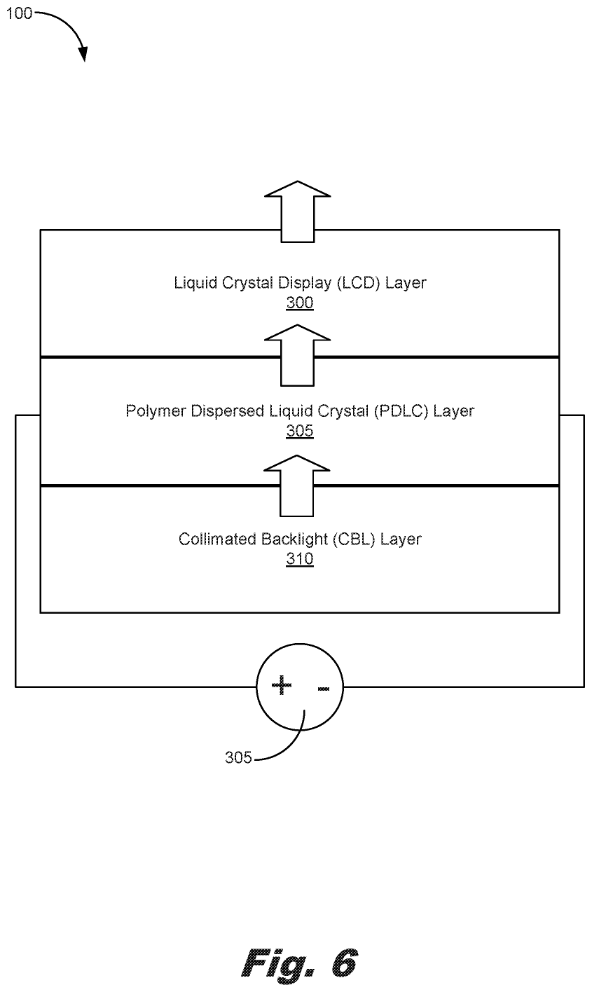

FIG. 6 is a block diagram of the privacy display (100) operating in a second luminance mode (135) during a sharing mode (125) according to an example of the principles described herein. Unlike the privacy display (100) depicted in FIG. 6, the voltage from the voltage source (305) is applied to the PDLC layer (110) allowing the collimated light from the CBL layer (105) to reach the backplane of the LCD layer (115). In this configuration, the relatively higher luminosity (i.e., above 400 nits) of the privacy display (100) allows any user at any angle relative to the privacy display (100) to view the images presented by the privacy display (100). Again, as described herein, the minimal luminance of the second luminance mode (135) depicted in FIG. 6 is 1.5 times or greater than a maximum luminance of the first luminance mode (130) depicted in FIG. 5.

The privacy display (100) may be implemented in any electronic device. Examples of electronic devices include servers, desktop computers, laptop computers, personal digital assistants (PDAs), mobile devices, smartphones, gaming systems, and tablets, among other electronic devices. These electronic devices may include a processor to, based on luminosity input from a user via, for example, a keyboard, change the luminosity of the privacy display (100) operating in a sharing mode (125) so that the privacy display (100) may be changed from the first luminance mode (130) to the second luminance mode (135) as described herein.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor of the privacy display (100) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a privacy display with a sharing mode operating in two distinct luminosity modes. These two luminosity modes allow for any user at any angle relative to the privacy display (100) to view the images presented. Additionally, the user may still operate the privacy display (100) in an absolute privacy mode (120) without and may be allowed to selectively switch from the privacy mode (120) to the sharing mode (125) and visa-versa.

The preceding description has been presented to illustrate and describe examples of the principles described. This description is not intended to be exhaustive or to limit these principles to any precise form disclosed. Many modifications and variations are possible in light of the above teaching.

What is claimed is:

1. A privacy display, comprising:
a collimated backlight (CBL) layer;
a polymer-dispersed liquid crystal (PDLC) layer; and
a liquid crystal display (LCD) layer;
wherein the PDLC layer is, upon selective application of a voltage, operates in a sharing mode and a privacy mode, the sharing mode being made to operate at a first luminance mode and a second luminance mode;
wherein, at the first luminance mode, the voltage is not applied to the PDLC layer and, at the second luminance mode, the voltage is applied to the PDLC; and
wherein a minimal luminance of the second luminance mode is 1.5 times or greater than a maximum luminance of the first luminance mode.

2. The privacy display of claim 1, wherein application of a voltage to the PDLC layer allows light emitted from the CBL layer to pass directly through the PDLC.

3. The privacy display of claim 1, wherein a threshold luminance defines a boundary between the first luminance mode and the second luminance mode and wherein the threshold is 400 nits.

4. The privacy display of claim 1, wherein the luminance of the first luminance mode and second luminance mode are measured at the center of the privacy display.

5. The privacy display of claim 1, wherein an increase in luminance is detectable at any viewing angle during the sharing mode when switching from the first luminance mode to the second luminance mode.

6. The privacy display of claim 1, wherein a color calibration is initiated during the sharing mode while operated within the first luminance mode.

7. The privacy display of claim 1, wherein a color calibration is initiated during the sharing mode while operated within the second luminance mode.

8. A method of operating a display device, comprising:
receiving input to selectively switch between a privacy mode and a sharing mode with a polymer-dispersed liquid crystal (PDLC) layer; and
when in a sharing mode and based on a threshold luminance level, selectively switching between a first luminance mode and a second luminance mode;
wherein a minimal luminance of the second luminance mode is 1.5 times or greater than a maximum luminance of the first luminance mode.

9. The method of claim 8, comprising initiating a color calibration during the sharing mode while operated within the first luminance mode.

10. The method of claim 8, comprising initiating a color calibration during the sharing mode while operated within the second luminance mode.

11. The method of claim 8, wherein an increase in luminance is detectable at any viewing angle during the sharing mode when switching from the first luminance mode to the second luminance mode.

12. The method of claim 8, wherein the PDLC layer is sandwiched between a collimated backlight (CBL) layer and a liquid crystal display (LCD) layer.

13. A computer program product for operating a display device, the computer program product comprising:
a computer readable storage medium comprising computer usable program code embodied therewith, the computer usable program code to, when executed by a processor:
receiving input to selectively switch between a privacy mode and a sharing mode with a polymer-dispersed liquid crystal (PDLC) layer;
when in a sharing mode and based on a threshold luminance level, selectively switching between a first luminance mode and a second luminance mode; and
set a minimal luminance of the second luminance mode at 1.5 times or greater than a maximum luminance of the first luminance mode.

14. The computer program product of claim 13, comprising computer program code to, when executed by a processor, initiate a color calibration during the sharing mode while operated within the first luminance mode,

15. The computer program product of claim 13, comprising computer program code to, when executed by a processor, initiate a color calibration during the sharing mode while operated within the second luminance mode.
